(19) United States
(12) Patent Application Publication
(10) Pub. No.: US 2025/0162029 A1
(43) Pub. Date: May 22, 2025

(54) ALLOY POWDER, METHOD FOR MANUFACTURING A PART BASED ON THIS ALLOY, AND PART THUS OBTAINED

(71) Applicants: Safran Aircraft Engines, Paris (FR); SAFRAN, PARIS (FR); ALLIANCE, SAINT-VIT (FR)

(72) Inventors: Hugo Jean-Louis SISTACH, MOISSY-CRAMAYEL (FR); Romaric Jean-Marie PIETTE, MOISSY-CRAMAYEL (FR); Cédric Pierre Jacques COLAS, MOISSY-CRAMAYEL (FR); Clément GILLOT, PLUMONT (FR); Jean-Claude BIHR, SAINT-VIT (FR)

(73) Assignees: Safran Aircraft Engines, Paris (FR); SAFRAN, PARIS (FR); ALLIANCE, SAINT-VIT (FR)

(21) Appl. No.: 18/840,318

(22) PCT Filed: Feb. 20, 2023
(86) PCT No.: PCT/FR2023/050232

§ 371 Date: Aug. 21, 2024

(30) Foreign Application Priority Data
Feb. 22, 2022 (FR) FR2201549

(51) Int. Cl. B22F 3/22; B22F 1/107; B22F 3/15; B22F 3/24

(52) U.S. Cl. CPC B22F 3/225; B22F 1/107; B22F 3/15; B22F 2003/248; B22F 2301/205; B22F 2304/10; B22F 2304/15

(57) ABSTRACT

The invention relates to a titanium-based alloy powder which comprises, in percentages by weight, 32.0 to 33.5% aluminium, 4.50 to 5.10% niobium, 2.40 to 2.70% chromium, 0 to 0.1% iron, 0 to 0.025% silicon, 0 to 100 ppm carbon, 0 to 100 ppm nitrogen, 0 to 1000 ppm dioxygen, 0 to 50 ppm dihydrogen and 0 to 500 ppm unavoidable impurities, the balance being titanium, and which has a D10 particle size of between 3 and 10 μm, a D90 particle size of between 20 and 40 μm and a D50 particle size of between 10 and 25 μm, the D10, D50 and D90 particle size values having been measured by laser diffraction in accordance with standard ISO 13322-2. The invention also relates to a method for manufacturing a part using this powder and to a part thus obtained.

### TECHNICAL FIELD

The invention relates to a titanium-based alloy powder intended, in particular, to be used in a manufacturing method by injection moulding of metal.

The invention also relates to such a manufacturing method using this powder, as well as a part, in particular for aeronautics, manufactured by this method.

### PRIOR ART

In a turbojet engine, the exhaust gases generated by the combustion chamber can reach high temperatures, greater than 1200° C., or even 1600° C. The parts of the turbojet engine in contact with these exhaust gases, such as the turbine blades/vanes for example, must therefore be capable of retaining their mechanical properties at these high temperatures.

For this purpose, it is known to manufacture certain parts of the turbojet engine from “superalloy”. Superalloys, typically nickel-based, are a family of highly resistant metal alloys which can operate at temperatures relatively close to their melting points (typically 0.7 to 0.9 times their melting temperatures). However, these alloys are very dense and their mass limits the efficiency of the turbines.

The intermetallic foundry alloy TiAl 48-2-2 has been used to manufacture certain turbine parts. More specifically, parts made of TiAl can operate up to 700° C. while retaining good mechanical resistance to creep, fatigue and traction, as well as good resistance to corrosion and oxidation. In addition, the intermetallic alloy TiAl has the advantage of being less dense than a nickel-based superalloy.

However, it remains difficult to obtain TiAl parts with good dimensions by conventional foundry processes, in particular when it concerns complex parts such as a turbine nozzle or turbine blades/vanes with internal channels or casing parts. The method which involves starting from a bar of TiAl, leads to significant loss of material and therefore to an unnecessary additional cost.

Another technique known from the prior art is metal powder injection moulding (known as Metal Injection Moulding or MIM). This method can advantageously be used for manufacturing complex turbomachine parts with the desired dimensions.

Several materials are commercially available for manufacturing turbomachine parts by the MIM method.

For example, nickel-based Inconel 718 is commonly used, but the part obtain cannot operate above 650° C., which is too low a temperature for use in the combustion chamber or in the turbine. In addition, this material is relatively massive.

Another available material is Hastelloy X, which enables the manufacture of parts which can operate up to 950° C. However, its mechanical properties are limited and it can only be used for very lightly loaded parts.

Finally, Rene 77 can be used to obtain parts that can operate up to 1000° C., while being subject to a high level of fatigue and creep. However, since this material is also a nickel-based alloy, the part obtain is relatively massive.

There is therefore a need to solve the above-mentioned problems.

### BRIEF DESCRIPTION OF THE INVENTION

One aim of the invention is therefore to propose a solution enabling complex parts to be obtained, such as, for example, turbine nozzles or turbine blades/vanes with internal channels, of controlled dimensions, made of an alloy material which has the same properties as foundry TiAl, namely good resistance to traction, fatigue, creep and oxidation/corrosion up to 700° C., while being much less massive than nickel-based alloys and which, moreover, can be used in an MIM moulding method.

Another aim of the invention is to obtain parts for aeronautics having a good surface state.

For this purpose, the invention proposes a titanium-based alloy powder, characterised in that it comprises, in percentages by weight, 32.0 to 33.5% aluminium, 4.50 to 5.10% niobium, 2.40 to 2.70% chromium, 0 to 0.1% iron, 0 to 0.025% silicon, 0 to 100 ppm carbon, 0 to 100 ppm nitrogen, 0 to 1000 ppm dioxygen, 0 to 50 ppm dihydrogen and 0 to 500 ppm unavoidable impurities, the balance being titanium, and in that it has:
a D10 particle size between 3 and 10 μm,
a D90 particle size between 20 and 40 μm and,
a D50 particle size between 10 and 25 μm,
   the values of the D10, D50 and D90 particle sizes having been measured by laser diffraction in accordance with standard ISO 13322-2.

The chemical composition and particle size of this alloy powder are chosen so that said alloy powder can be used in a powder injection moulding method and in order to obtain, at the end of the method, an alloy part having good resistance to traction, fatigue and creep, and good resistance to corrosion and oxidation up to 700° C., while being less massive than a nickel-based alloy.

The invention also relates to a method for manufacturing a part, in particular for aeronautics, characterised in that it comprises the following steps:
a step of mixing the titanium-based alloy powder according to the invention, with at least one plastic binder,
a step of granulation of this mixture, in such a way as to obtain granules of alloy and plastic mixture,
a step of injection moulding of the mixture granules in a mould, in order to obtain a green part,
a debinding step in order to obtain a debound part,
a step of sintering the debound part in order to obtain a sintered part.

This method makes it possible to obtain, starting from the alloy powder described above, complex parts with controlled dimensions and having a good surface state.

This method also makes it possible to obtain parts having good resistance to traction, fatigue and creep, and good resistance to corrosion and oxidation up to 700° C., while being less massive than a part made of a nickel-based alloy.

According to other advantageous and non-limiting features of the invention, taken alone or in combination:
the method further comprises a step of hot isostatic compacting which consists of a heat treatment at a temperature between 1175° C. and 1195° C., preferably at a temperature of 1185° C. for a duration between 1 hour and 5 hours, preferably for 3 hours under a pressure between 125 MPa and 150 MPa, this step being carried out after sintering E6,
the method further comprises a step of quenching the sintered part, which consists of a heat treatment of the sintered part at a temperature between 1140° C. and 1160° C. for 3 hours, under a pressure between 125 MPa and 150 MPa, for the first two hours, then under a pressure between 100 MPa and 125 MPa for the last hour, this step being carried out after the sintering step or after the hot isostatic compacting step,
the volumetric alloy loading rate of the granules of alloy and plastic mixture is between 50% and 75% and the melt flow index of said granules is between 60 cm³/10 min and 85 cm³/10 min at a temperature between 190° C. and 230° C., and the injection temperature during the moulding step is between 160° C. and 200° C., the measurement of the melt flow index being performed in accordance with standard ISO 1133-1,
the diameter of the granules of alloy and plastic mixture is between 1 mm and 5 mm,
the debinding step itself comprises two successive steps: a first chemical step of primary debinding of the green part in such a way as to obtain a partially debound part, and a second step of thermal debinding of the partially debound part in order to obtain a debound part,
the primary debinding step is a catalytic debinding under nitrogen, in the presence of nitric acid fumes, for a duration between 2 and 10 hours, the flow rate of nitric acid fumes being between 2 mL/min and 5 mL/min, the temperature being between 100° C. and 150° C.,
the primary debinding step is a debinding by solvent with demineralised water, under stirring of the water, the temperature of the water being between 20° C. and 100° C., for a duration between 100 h and 400 h.,
the thermal debinding step is carried out under argon in two successive temperature stages, the first temperature stage being between 250° C. and 450° C. for 100 minutes to 300 minutes, the second temperature stage being between 350° C. and 550° for 100 minutes to 300 minutes,
the step of sintering the debound part is carried out by the application of a temperature between 1400° C. and 1450° C. for a duration between 2 and 6 hours under an argon atmosphere.

Finally, the invention relates to a titanium-based alloy part, in particular for aeronautics, characterised in that it is manufactured by the manufacturing method as described above.

According to other advantageous and non-limiting features of the invention, taken alone or in combination:
the part comprises, in percentages by weight, between 32.0 and 33.5% aluminium, between 4.50 and 5.10% niobium, between 2.40 and 2.70% chromium, less than 0.1% iron, less than 2000 ppm dioxygen, less than 0.025% silicon, less than 350 ppm carbon, less than 200 ppm nitrogen, less than 100 ppm dihydrogen and less than 500 ppm unavoidable impurities, the balance being titanium, and it also has a duplex to low duplex microstructure with between 10% and 60% multiphase lamellar grains and between 90% and 40% gamma grains.
the part is a turbine blade/vane or a turbine nozzle.

### BRIEF DESCRIPTION OF THE FIGURES

Other features and advantages of the invention will become apparent from the detailed description which follows with reference to the appended drawings in which:

FIG. 1 shows an electron microscope image of a part made of foundry TiAl 48-2-2 after a series of heat treatments.

FIG. 2 schematically shows the various steps of the manufacturing method according to the invention.

FIG. 3 is an electron microscope image of a part obtained at the end of the sintering step of the manufacturing method according to the invention

FIG. 4 is an electron microscope image of a part obtained at the end of the hot isostatic compacting (CIC) step and the quenching step of the manufacturing method according to the invention.

### DETAILED DESCRIPTION OF THE EMBODIMENTS

The foundry alloy TiAl 48-2-2 comprises, in percentage by weight, between 32.0% and 33.5% aluminium, between 4.50% and 5.10% niobium, between 2.40% and 2.70% chromium, less than 0.10% iron, less than 0.015% carbon, less than 0.02% nitrogen, less than 0.01% hydrogen, between 0.04% and 0.13% dioxygen, less than 0.05% other elements which constitute unavoidable impurities, the balance consisting of titanium which is the base of the alloy.

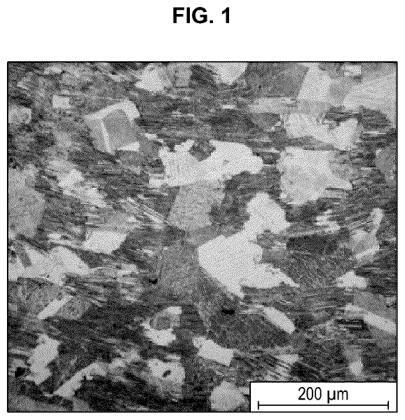

FIG. 1 is a representation of a foundry TiAl 48-2-2 microstructure, with duplex microstructure, obtained after a series of heat treatments, in which can be seen, in grey, two-phase lamellar grains and, in white, single-phase gamma grains. The term “duplex” means that the microstructure comprises two types of phases.

The intermetallic alloy TiAl 48-2-2 has mechanical and chemical properties of interest for applications in the field of turbomachines. The TiAl 48-2-2 parts retain good mechanical resistance to creep, fatigue and traction, as well as good resistance to corrosion and oxidation up to 700° C. In addition, the TiAl alloy is less dense than a nickel-based superalloy.

On the other hand, metal injection moulding makes it possible to obtain parts with complex shapes with an excellent surface state, and to precisely control the dimensions of said parts. In addition, metal injection moulding is a method which is distinguished by its quick implementation.

The invention relates to an alloy powder and to a method, the parameters of which have been chosen in order to obtain, from the alloy powder and at the end of the method, parts which advantageously combine the properties of a TiAl 48-2-2 alloy part and those of a part from a metal injection moulding method.

The MIM method is a method for moulding parts by injecting a mixture of metal powder and plastic binder into a mould. The strength of the injected part is ensured by the plastic binder. The plastic binder is removed during subsequent steps, referred to as debinding steps. The debound part is fragile, because it is very porous. An additional sintering step is necessary during which the metal powder grains bind together.

Titanium Aluminium Alloy Powder which can be Used in Metal Injection Moulding

The invention relates to a titanium-based metal alloy powder. The chemical composition and the particle size of the alloy powder have been chosen in order to enable its use in a metal injection moulding (MIM) method and to obtain, at the end of the method, a titanium-based alloy part, the chemical composition of which is close to that of the foundry alloy TiAl 48-2-2 and the mechanical properties of which are improved.

### Chemical Composition of the Powder

Even though the plastic binder is almost entirely removed during the debinding steps described above, residues of this plastic binder impregnate the metal material. The content of nitrogen, dioxygen and carbon are larger in the moulded part coming from the powder injection moulding method than in the powder which was injected at the start of the method.

However, the content of carbon, nitrogen and dioxygen given in the specification for TiAl 48-2-2 are relatively low with respect to the expected mechanical properties. A high carbon content leads, for example, to the formation of carbides at the grain boundaries, which block the growth and movement of said grains. The part is therefore less ductile and risks breaking during use. High contents of dioxygen and nitrogen also lead to a reduction in ductility of the part and rapid breaking under fatigue and traction.

The content the various elements of the alloy powder of the invention, in particular the content of nitrogen, dioxygen and carbon, have thus been chosen as a consequence.

The alloy powder according to the invention comprises, in percentages by weight, 32.0 to 33.5% aluminium, 4.50 to 5.10% niobium, 2.40 to 2.70% chromium, 0 to 0.1% iron, 0 to 0.025% silicon, 0 to 100 ppm carbon, 0 to 100 ppm nitrogen, 0 to 1000 ppm dioxygen, 0 to 50 ppm dihydrogen and 0 to 500 ppm unavoidable impurities, the balance being titanium.

“Unavoidable impurities” are defined as the elements which are unintentionally added to the composition of the powder and which are contributed by other elements. Such unavoidable impurities may include, for example, yttrium which comes from the crucibles used for the atomisation of the powder.

### Particle Size of the Powder

The particle size of the powder has been chosen in order that the powder can be used in the manufacturing method described below, in particular during the injection and sintering steps.

The implementation of the powder injection moulding method requires the size of the grains of powder to be controlled, in order to ensure good injection of the mixture of alloy powder and plastic binder into the mould of the part. More specifically, small size grains of alloy powder result in a large contact interface between the alloy powder and the plastic binder within the mixture of alloy powder and plastic binder, and therefore a high level of friction during injection of said mixture into the mould of the part. By contrast, alloy powder grains which are too large are more difficult to transport by the plastic binder during said injection and can therefore lead to an inhomogeneous injected part.

In addition, the particle size is important in order to obtain good sintering, a step during which the grains will defuse and bind to one another, so as to remove their interfaces and thus lower their entropy. Fine powder will therefore be more easily sintered because, by grouping together, the small powder grains strongly reduce their interfaces and their surfaces, causing their entropy to be significantly reduced.

The size of the alloy powder grains of the invention has therefore been defined by a range of acceptable values for the D10, D50 and D90 particle sizes of said alloy powder.

The D10 particle size corresponds to 10% passing. In other words, 10% by number of the alloy powder grains have a diameter less than D10. Similarly, the D50 and D90 particle sizes corresponded to 50% and 90% passing, respectively.

The D10 particle size of the alloy powder in accordance with the invention is between 3 and 10 μm. The D50 particle size D50 is between 10 and 25 μm. Finally, the D90 particle size is between 20 and 40 μm.

The values for the D10, D50 and D90 particle sizes have been measured in accordance with standard ISO 13322-2. This standard envisages measurement by laser diffraction.

### Preparation of the Powder

The titanium-based alloy powder that is the object of the invention can, for example, be obtained from the base elements of the TiAl 48-2-2 alloy, by a powder atomisation method. The atomisation method can provide the chemical composition and the particle size of the obtained alloy powder. In addition, it can ensure good morphology of the powder, which is mostly spherical. Finally, it can limit the risk of pollution.

### Metal Injection Moulding Method

The invention also relates to a method for manufacturing a part, in particular for aeronautics, which uses the titanium-based alloy powder defined above.

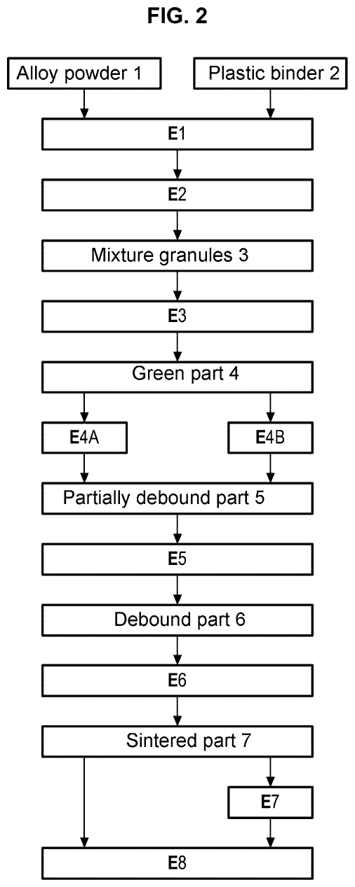

In general, this method comprises successive steps of mixing, granulation, injection moulding, chemical debinding, thermal debinding, sintering and quenching. These steps are described in more detail below with reference to FIG. 2.

### Mixing

In a first, mixing step E1, the titanium-based alloy powder 1 according to the invention is mixed with at least one plastic binder 2, preferably two plastic binders. This binder 2 is, for example, polyethylene (PE) or polyethylene glycol (PEG) or a mixture of the two. During mixing step E1, the temperature is fixed at a value such that the plastic is pasty in order to allow good mixing. The temperature depends on the composition of the plastic, it is for example between 50° C. and 150° C. During the mixing step E1, the titanium-based alloy powder 1 and the plastic binder 2 are mixed in proportions chosen so as to obtain, at the end of granulation step E2 described below, granules of alloy and plastic mixture 3 having a melt flow index which guarantees an efficient injection of the said granules 3 during moulding step E3. The mixture of alloy powder 1 and the at least one plastic binder 2 preferably comprises, in percentage by volume, between 50% and 75% alloy powder 1 and between 50% and 25% plastic binder 2, such that the mixture granules 3 have a melt flow index between 60 cm³/10 min and 85 cm³/10 min at a temperature between 190° C. and 230° C., the measurement of the melt flow index being performed in accordance with standard ISO 1133-1.

### Granulation.

In a second step E2 of granulation of the mixture of the alloy powder and the at least one plastic binder, the mixture from step E1 is passed into an extruder in order to obtain granules 3 of alloy and plastic mixture, known to a person skilled in the art as “feedstock”. The shape and size of the granules of alloy and plastic mixture 3 are fixed by the parameter settings of the extruder. The granules of alloy and plastic mixture 3 are, for example, cylinders with a base diameter that is preferably between 1 mm and 5 mm.

### Moulding.

In a third, moulding step E3, the granules 3 of alloy and plastic mixture are injected into the mould of the part to be manufactured, the injection temperature being between 160° C. and 200° C. Below 160° C., the mixture is too solid and will not go into the mould. Above 200° C., the mixture is too liquid, the alloy powder and the plastic binder separate and the alloy powder is not transported. The other parameters, such as injection speed, injection pressure, holding time after injection or the injection time, depend on the part to be injected.

Following moulding step E3, a green part 4 is obtained, which is a part made from alloy powder and plastic mixtures (alloy grains in suspension in the plastic). The adjustment of the moulding parameters makes it possible to obtain a part without pores. The plastic binder ensures the strength of the part.

### Debinding.

“Debinding” enables the plastic binder to be removed from the previously obtained green part 4.

Two debinding steps are carried out in succession, one chemical and the other thermal.

### Primary Debinding

The primary debinding E4 is a chemical debinding. The primary debinding E4 enables a partially debound part 5 to be obtained.

This debinding can be chosen as: either debinding using a solvent E4B, or preferably a catalytic debinding E4A. The latter has the advantage of being quicker.

Catalytic debinding E4A involves vaporising then burning the plastic binder by injecting acid fumes into the oven.

The catalytic debinding is carried out, for example, at a temperature between 100° C. and 150° C. for 2 to 10 hours, under a nitrogen atmosphere, in the presence of nitric acid fumes, the flow of nitric acid being preferably between 2 mL/min and 5 mL/min.

The debinding E4B using a solvent involves bathing the green part 4 in a bath of said solvent, in such a way as to dissolve the plastic.

The debinding E4B is, for example, a debinding using water, the green part 4 being immersed for 100 hours to 400 hours in a bath of demineralised water under stirring, at a temperature between 20° C. and 100° C., preferably of order 60° C.

At the end of the chemical debinding step E4, the partially debound part 5 is obtained, the chemical debinding having enabled more than 95% of the plastic binder to be removed.

### Thermal Debinding

The thermal debinding E5 is preferably carried out by the successive application of two temperature stages, under an argon atmosphere, at the partially debound part. During the first stage, a temperature between 250° C. and 450° C. is applied for 100 minutes to 300 minutes. During the second stage, a temperature between 350° C. and 550° C. is applied for 100 to 300 minutes.

At the end of the thermal debinding step (E5), a debound part or “brown part” is obtained, the thermal debinding having enabled the remaining plastic binder to be removed (in other words the remaining less than 5%).

The debound part 6 coming from the primary E4 and thermal E5 debinding steps, is a part with the same dimensions as the green part 4. However, in contrast to the green part 4, the debound part 6 is highly porous because the plastic binder has been removed, the density of the debound part 6 is between 50% and 75% of the density of a foundry TiAl alloy part. In addition, the debound part 6 is very fragile, because the plastic binder which ensures the strength of the part has been removed.

### Sintering

The sintering of the debound part 6 is carried out during a step E6. The sintering consists of subjecting the debound part 6 to a temperature close of the melting point of the alloy powder, in such a way that the grains of powder bind together. During the sintering, the part shrinks and its density increases.

The sintering is implemented in an oven, preferably at a temperature between 1400° C. and 1450° C. for 2 to 6 hours under an argon atmosphere.

The thermal debinding step E5 and the sintering step E6 are preferably carried out in the same oven, because the debound part 6 is fragile.

At the end of the sintering step E6, a more compact sintered part 7 is obtained, the density of which is preferably greater than 95% of the density of a conventional foundry TiAl alloy. The dimensions of the sintered part 7 are smaller than those of the debound part or brown part 6. Typically, a reduction in size of between 14 and 18% is observed.

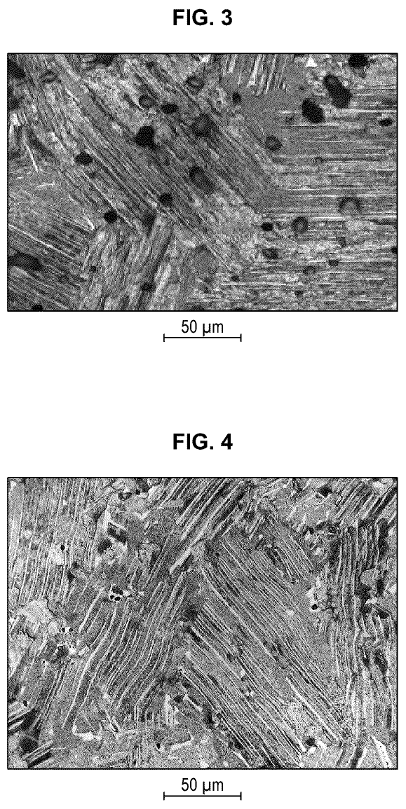

FIG. 3 is an electron microscope image of a part obtained at the end of the sintering step of the method according to the invention. A microstructure in the form of needles can be seen, characteristic of a titanium-based alloy, the grains are connected and the material is relatively dense. However, the material also comprises residual pores (see the small round black spots) which can harm the mechanical properties of the final part. Heat treatments can be implemented in order to remove said residual pores.

In addition, the sintered part made of titanium-based alloy 7 comprises, in percentages by weight, between 32.0% and 33.5% aluminium, between 4.50% and 5.10% niobium, between 2.40% and 2.70% chromium, less than 0.1% iron, less than 2000 ppm dioxygen, less than 0.025% silicon, less than 350 ppm carbon, less than 200 ppm nitrogen, less than 100 ppm dihydrogen and less than 500 ppm unavoidable impurities.

The chemical composition of the sintered part 7 is very close to that of the initial alloy powder. Only the content of carbon, dioxygen and nitrogen significantly increases during the MIM method.

By way of example, if the alloy powder 1 comprises 970 ppm dioxygen, 90 ppm nitrogen and 70 ppm carbon, the sintered part 7 obtained at the end of the method according to the invention starting from the alloy powder 1, comprises 1600 ppm dioxygen, 120 ppm nitrogen and 340 ppm carbon.

The additional elements carbon, oxygen and nitrogen are residues of the plastic binder which has impregnated the metal material. However, contents of the said elements which are too high can have a negative impact on the mechanical properties of the alloy part from the MIM method The alloy powder 1 must have contents of carbon, dioxygen and nitrogen very much lower than those of the targeted TiAl 48-2-2.

### Hot Isostatic Compacting

Optionally, hot isostatic compacting step E7 of the sintered part can be implemented in order to refill the residual pores, in particular if the density of the sintered part is less than 95% of the density of the foundry TiAl alloy. The hot isostatic compacting step E7 can increase the density of the part 7 coming from the sintering by up to 100% of the density of the foundry TiAl and improve the mechanical properties of said part. In addition, the hot isostatic compacting step E7 can reduce the size dispersion of parts coming from the metal injection moulding method.

During the hot isostatic compacting step E7, high pressure and temperature are jointly applied under an inert atmosphere. For example, a temperature between 1175° C. and 1195° C., preferably a temperature of 1185° C., and a pressure between 125 MPa and 150 MPa, preferably between 132 and 140 MPa are applied for a duration between 1 hours and 5 hours, preferably for 3 hours, under an inert atmosphere, for example an atmosphere of helium or vacuum, preferably an argon atmosphere.

### Quenching.

Finally, a quenching heat treatment step E8 is implemented. The quenching heat treatment consists of heating the part to a temperature at which the good alloying elements titanium and aluminium are dissolved, for a sufficiently long time to allow said elements to be redissolved and diffused into the crystalline solid. The part is then cooled relatively quickly, in order that said good alloying elements re-precipitate. This step makes it possible to obtain a final part with the expected mechanical and chemical properties.

The quenching heat treatment step E8 is preferably performed at a temperature of 1150° C. for 3 hours. If the hot isostatic compacting step (E7) has been implemented beforehand, the temperature is lowered from 1185° C. to 1150° C. while maintaining an inert atmosphere. In parallel with the application of this temperature, a pressure is applied at between 125 MPa and 150 MPa, preferably between 132 and 140 MPa for two hours, then a pressure between 100 and 125 MPa, preferably between 115 MPa and 125 MPa for one hour. The part is finally cooled at a rate between 11° C./min and 70° C./min until reaching a temperature between 690° C. and 710° C., preferably a temperature of 700° C. Throughout the quenching heat treatment step E8 which comprises heating then cooling of the part, an inert atmosphere is maintained, for example an atmosphere of argon, the cooling being carried out at atmospheric pressure.

FIG. 4 is an electron microscope image of a part obtained at the end of steps E7 and E8 of the method according to the invention. The needle microstructure can be recognised, but the spots can no longer be seen. The hot isostatic compacting step E7 has therefore enabled the last pores to be refilled and a completely healthy material to be obtained.

### Parts Obtained by the Method

The invention also relates to parts obtained by the manufacturing method using the alloy powder according to the invention.

Said parts are titanium-based alloy parts comprising, in particular, in percentages by weight, less than 350 ppm carbon, less than 200 ppm nitrogen and less than 2000 ppm dioxygen, the chemical compositions being measured by elementary analysis, for example by inductively coupled plasma spectroscopy. The properties of parts having said compositions of carbon, nitrogen and dioxygen are comparable or even greater than those of parts made of foundry TiAl.

In FIG. 1, which shows a part made from foundry TiAl, it can be seen that this has a duplex microstructure with two-phase lamellar grains and single-phase gamma grains.

By contrast, and as can be seen in FIG. 4, the parts obtained from the manufacturing method using the alloy powder according to the invention have a multiphase duplex to low duplex microstructure, with between 10% and 60% multiphase lamellar grains and between 90% and 40% gamma grains, which gives them better resistance to traction and fatigue than a foundry TiAl part. More specifically, for temperatures between 0° C. and 800° C., the limiting stress driving rupture in traction Rₘ of parts obtained from the manufacturing method using said powder is greater than 250 MPa. The elasticity limit with 0.2% residual plastic deformation of said parts Rp_{0.2} is reached for a stress greater than 150 MPa. The gain in fatigue and in elasticity (with 0.2% plastic deformation) is at least 10% compared with a foundry TiAl part, up to 700° C.

The invention has a particular application in the manufacture of parts for aeronautics, such as turbine blades/vanes for example, including blades/vanes with internal channels, turbine nozzles or casing parts which are subject to high stresses, must resist corrosion, and are used at high temperatures greater than 600° C.

1. A titanium-based alloy powder, comprising, in percentages by weight, 32.0 to 33.5% aluminium, 4.50 to 5.10% niobium, 2.40 to 2.70% chromium, 0 to 0.1% iron, 0 to 0.025% silicon, 0 to 100 ppm carbon, 0 to 100 ppm nitrogen, 0 to 1000 ppm dioxygen, 0 to 50 ppm dihydrogen and 0 to 500 ppm unavoidable impurities, the balance being titanium,
wherein the titanium-based alloy powder has:
a D10 particle size between 3 and 10 μm,
a D90 particle size between 20 and 40 μm and,
a D50 particle size between 10 and 25 μm, the values of the D10, D50 and D90 particle sizes being measured by laser diffraction in accordance with standard ISO 13322-2.

2. A method for manufacturing a part, comprising the following steps:
a step of mixing the titanium-based alloy powder according to claim 1 with at least one plastic binder to obtain a mixture,
a step of granulation of the mixture, so as to obtain granules of alloy and plastic mixture,
a step of injection moulding the granules of alloy and plastic mixture in a mould, in order to obtain a green part,
a step of debinding the green part, to obtain a debound part,
a step of sintering the debound part, to obtain a sintered part.

3. The method of claim 2, further comprising, after the step of sintering, a step (E7) of hot isostatic compacting which consists of a heat treatment at a temperature between 1175° C. and 1195° C. for a duration between 1 hour and 5 hours under a pressure between 125 MPa and 150 MPa.

4. The method of claim 2, further comprising, after the step of sintering or after the step of hot isostatic compacting, a step of quenching the sintered part which consists of a heat treatment of the sintered part at a temperature between 1140° C. and 1160° C. for 3 hours, under a pressure between 125 and 150 MPa for the first two hours, then under a pressure between 100 and 125 MPa for the last hour.

5. The method of claim 2, wherein a volumetric alloy loading rate of the granules of alloy and plastic mixture is between 50% and 75% and a melt flow index of said granules is between 60 cm³/10 min and 85 cm³/10 min at a temperature between 190° C. and 230° C., and wherein an injection temperature during the step of moulding is between 160° C. and 200° C., the measurement of the melt flow index being performed in accordance with standard ISO 1133-1.

6. The method of claim 2, wherein a diameter of the granules of alloy and plastic mixture is between 1 mm and 5 mm.

7. The method of claim 2 wherein the step of debinding step of chemical debinding followed by a second step of thermal debinding.

8. The method of claim 7, wherein the first step of chemical debinding is a catalytic debinding under nitrogen, in the presence of nitric acid fumes, for a duration between 2 and 10 hours, the flow rate of nitric acid fumes being between 2 mL/min and 5 mL/min, the temperature being between 100° and 150° C.

9. The method of claim 7, wherein the first step of chemical debinding is a debinding by solvent with demineralised water (E4B), under stirring of the water, the temperature of the water being between 2° and 100° C. for a duration between 100 and 400 h.

10. The method of claim 7, wherein the second step of thermal debinding is carried out under argon in two successive temperature stages, the first temperature stage being between 250° C. and 450° C. for 100 to 300 minutes, the second temperature stage being between 350° C. and 550° C. for 100 to 300 minutes.

11. The method of claim 2, wherein the step of sintering the debound part is carried out by applying a temperature between 140° and 1450° C. for a duration between 2 and 6 hours under an argon atmosphere.

12. (canceled)

13. A titanium-based alloy part, comprising, in percentages by weight, between 32.0 and 33.5% aluminium, between 4.50 and 5.10% niobium, between 2.40 and 2.70% chromium, less than 0.1% iron, less than 2000 ppm dioxygen, less than 0.025% silicon, less than 350 ppm carbon, less than 200 ppm nitrogen, less than 100 ppm dihydrogen and less than 500 ppm unavoidable impurities, the balance being titanium, and in that it also has a duplex to low duplex microstructure with between 10% and 60% multiphase lamellar grains and between 90% and 40% gamma grains.

14. (canceled)
